(19) United States
(12) Patent Application Publication
(10) Pub. No.: US 2010/0018218 A1
(43) Pub. Date: Jan. 28, 2010

(54) Power plant with emissions recovery

(76) Inventors: Horace E. Riley, Arlington, TX (US); Thomas E. Boyd, Colleyville, TX (US)

Correspondence Address: LYNN E BARBER, P O BOX 16528, FORT WORTH, TX, 76162, US

(21) Appl. No.: 12/220,647

(22) Filed: Jul. 25, 2008

(51) Int. Cl. F02C 6/00; F02C 6/06; F25J 3/00; F01N 3/01; F02C 3/22; F02C 3/34

(52) U.S. Cl. 60/783; 60/39.12; 60/39.461; 60/39.5

(57) ABSTRACT

A power plant including an air separation unit (ASU) arranged to separate nitrogen, oxygen, carbon dioxide and argon from air and produce a stream of substantially pure liquid oxygen, nitrogen, carbon dioxide and argon; a steam generator, fired or unfired, arranged to combust a fuel, e.g., natural gas, liquefied natural gas, synthesis gas, coal, petroleum coke, biomass, municipal solid waste or any other gaseous, liquid or solid fuel in the presence of air and a quantity of substantially pure oxygen gas to produce an exhaust gas comprising water, carbon dioxide, carbon monoxide, nitrogen oxides, nitrogen, sulfur oxides and other trace gases, and a steam-turbine-generator to produce electricity, a primary gas heat exchanger unit for particulate/acid gas/moisture removal and a secondary heat exchanger arranged to cool the remainder of the exhaust gases from the steam generator. Exhaust gases are liquefied in the ASU thereby recovering carbon dioxide, nitrogen oxides, nitrogen, sulfur oxides, oxygen, and all other trace gases from the steam generator exhaust gas stream. The cooled gases are liquefied in the ASU and separated for sale or re-use in the power plant. Carbon dioxide liquid is transported from the plant for use in enhanced oil recovery or for other commercial use. Carbon dioxide removal is accomplished in the ASU by cryogenic separation of the gases, after directing the stream of liquid nitrogen from the air separation unit to the exhaust gas heat exchanger units to cool all of the exhaust gases including carbon dioxide, carbon monoxide, nitrogen oxides, nitrogen, oxygen, sulfur oxides, and other trace gases.

### BACKGROUND OF THE INVENTION

1. Field of the Invention

This invention relates to an improved power plant, i.e., an electrical power generating plant, with complete emissions recovery, producing power that will be transported and sold on the nearest electrical transmission grid or grids.

2. Description of the Related Art

The invention relates to a new or existing improved power plant, i.e., an electrical power generating plant, with complete emissions recovery. The plant of the invention emits no pollutants, and achieves a zero pollutant emission state of operation. Environmental pollution from fossil-fueled power plants is of worldwide concern. Power plants emit air pollutants such as, toxic metals and hydrocarbons; precursors to acid rain, e.g., sulfur oxides such as sulfur dioxide (SO₂), and nitrogen oxides; precursors to ozone such as NO₂ and reactive organic gases; particulate matter; and greenhouse gases, notably CO₂.

Although certain methods and technologies have been developed that reduce emissions and effluents, they are expensive and consume considerable electrical energy. For example, the use of natural gas as a fuel instead of petroleum or coal reduces some emissions and solids wastes. However, burning natural gas in air still produces copious quantities of NO₂, reactive organic gases, and CO₂.

The CO₂ can be removed from the exhaust gas using several known methods including air separation/exhaust gas recycling, amine scrubbing, cryogenic fractionation, and membrane separation. Of all the methods, air separation/exhaust gas recycling is considered to be the most cost and energy efficient, although amine scrubbing is a close competitor. Nevertheless, all of these methods significantly impair the overall efficiency of the power plants in which they are used.

Prior patents include that of Meratla (U.S. Pat. No. 5,467,722 for a method and apparatus for removing pollutants from flue gas); Viteri (U.S. Pat. No. 5,680,764 for clean air engines transportation and other power applications); Golomb et al. (U.S. Pat. No. 5,724,805 for a power plant with carbon dioxide capture and zero pollutant emission); Frutschi et al. (U.S. Pat. No. 6,269,624 for a method of operating a power plant with recycled CO₂); and Cheng et al. (U.S. Pat. No. 5,634,355 for a cryogenic system for recovery of volatile compounds and U.S. Pat. No. 6,505,472 for a cryogenic condensation system). All publications, patent applications, patents, and other references mentioned herein are incorporated by reference.

### SUMMARY OF THE INVENTION

The invention features a new or existing improved power plant that captures CO₂ and emits no pollutants. The plant is so effective in removing pollutants from the exhaust gases that it requires no chimney. This plant can be fueled by natural gas, liquid natural gas, synthesis gas, coal, petroleum coke, biomass, MSW, or any other gaseous, liquid, or solid fuel. The outstanding benefit of the plant is in recovering 100 percent of the CO₂ from the exhaust gas. The captured CO₂ is sequestered underground and used for enhanced oil recovery, as a chemical feedstock, or for commercial uses.

The new or existing power plant offers two significant advantages: (1) it is environmentally safe as the result of CO₂ capture and zero nitrogen oxides and sulfur oxides emissions, and in the case of coal, the elimination of the release of mercury into the atmosphere; and (2) it produces by-products in a suitable physical state for easy delivery and commercial use.

In general, the invention features a new or existing power plant that includes an air separation unit arranged to separate nitrogen, nitrogen oxides, oxygen, carbon dioxide, carbon monoxide, sulfur oxides, argon and trace gases from air and the steam generator exhaust gases. The air separation unit produces a stream of greater than 95% pure liquid oxygen. It features a steam generator arranged to combust a variety of fuels, such as, natural gas, liquefied natural gas, synthesis gas, coal, petroleum coke, biomass, MSW (Municipal Solid Waste), or any other gaseous, liquid, or solid fuel in the presence of combustion air and 95% pure oxygen gas, and produces an exhaust gas comprising water vapor, nitrogen, nitrogen oxides, carbon dioxide, carbon monoxide, sulfur oxides, oxygen, argon, and other trace gases; a steam turbine-generator taking steam from the steam generator and producing electricity, a heat exchanger unit arranged to recover water vapor/particulates from the exhaust gas, a heat exchanger to cool the remaining exhaust gases before passage through the ASU, and liquefies the remainder of the exhaust gases in the ASU for removal from the plant. In this new plant, the carbon dioxide removal is integrated with the air separation unit.

The air separation unit can also separate nitrogen from the air and produces a stream of cold, 99% pure nitrogen. The cold nitrogen is directed to cool the exhaust gases prior to separation of carbon dioxide, oxygen and nitrogen, and other trace gases.

In the power plant of the invention, 100 percent of the carbon dioxide, recovered from the exhaust gas, is liquefied for removal from the plant when the power plant is operated in steady state or variable operation.

Other objects and advantages will be more fully apparent from the following disclosure and appended claims.

### SUMMARY OF THE INVENTION

The invention herein is a power plant comprising an air separation unit arranged to separate nitrogen, oxygen, carbon dioxide, and argon from air and steam generator exhaust gases and produce a stream of substantially pure liquid nitrogen, oxygen, carbon dioxide, argon, and other trace gases; and a steam generator or heat recovery steam generator arranged to combust a fuel in the presence of air and injected substantially pure oxygen gas to produce an exhaust gas comprising water, nitrogen oxides, nitrogen, carbon dioxide, carbon monoxide, oxygen, argon, and other trace gases, and produces steam used by a steam turbine-generator to produce electricity, and a heat exchanger to remove water vapor, and cool all exhaust gases prior to liquefaction in the ASU.

Other objects and features of the inventions will be more fully apparent from the following disclosure and appended claims.

### BRIEF DESCRIPTION OF THE DRAWINGS

FIG. 1 is a block diagram of the overall organization of the new power plant.

FIG. 2 is a block diagram of the air separation unit with carbon dioxide capture.

### DETAILED DESCRIPTION OF THE INVENTION AND PREFERRED EMBODIMENTS THEREOF

The present invention provides an improved plant combining several basic principles with new techniques. Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, the preferred methods and materials are described below. The materials, methods, and examples are illustrative only and not intended to be limiting.

Basically the invention herein is a power plant comprising: an air separation unit 10 arranged to separate nitrogen, oxygen, carbon dioxide, and argon from air and steam generator exhaust gases and produce a stream of substantially pure liquid nitrogen, oxygen, carbon dioxide, argon, and other trace gases; and a steam generator 16 (or heat recovery steam generator) arranged to combust a fuel in the presence of air and injected substantially pure oxygen gas to produce an exhaust gas comprising water, nitrogen oxides, nitrogen, carbon dioxide, carbon monoxide, oxygen, argon, and other trace gases. In the power plant of the invention, the fuel is selected from the group consisting of natural gas, liquefied natural gas, synthesis gas, coal, petroleum coke, biomass, MSW (Municipal Solid Waste), or any other gaseous, liquid, or solid fuel.

The air separation unit 10 separates oxygen, nitrogen, and argon from the air and produces a stream of cold, substantially pure nitrogen, and the cold nitrogen is directed to cool the steam generator exhaust gases prior to separation of nitrogen, oxygen, nitrogen oxides, carbon dioxide, carbon monoxide, sulfur oxides, argon, and other traces gases. Preferably the substantially pure nitrogen is at least 98 percent nitrogen in the form of a liquid, the substantially pure liquid oxygen gas is at least 95 percent oxygen, preferably pressurized to a pressure of at least 250 psig, and 100 percent of the recovered exhaust carbon dioxide is liquefied and removed from the plant by pipeline or truck for enhanced oil recovery or other commercial uses.

The power plant of the invention can operate in steady state or variable output operation, with the choice of mode of operation by the system operator being based on power plants and needs thereof. An amount of carbon dioxide equal to 100 percent of the carbon dioxide produced from combustion is liquefied for removal from the plant.

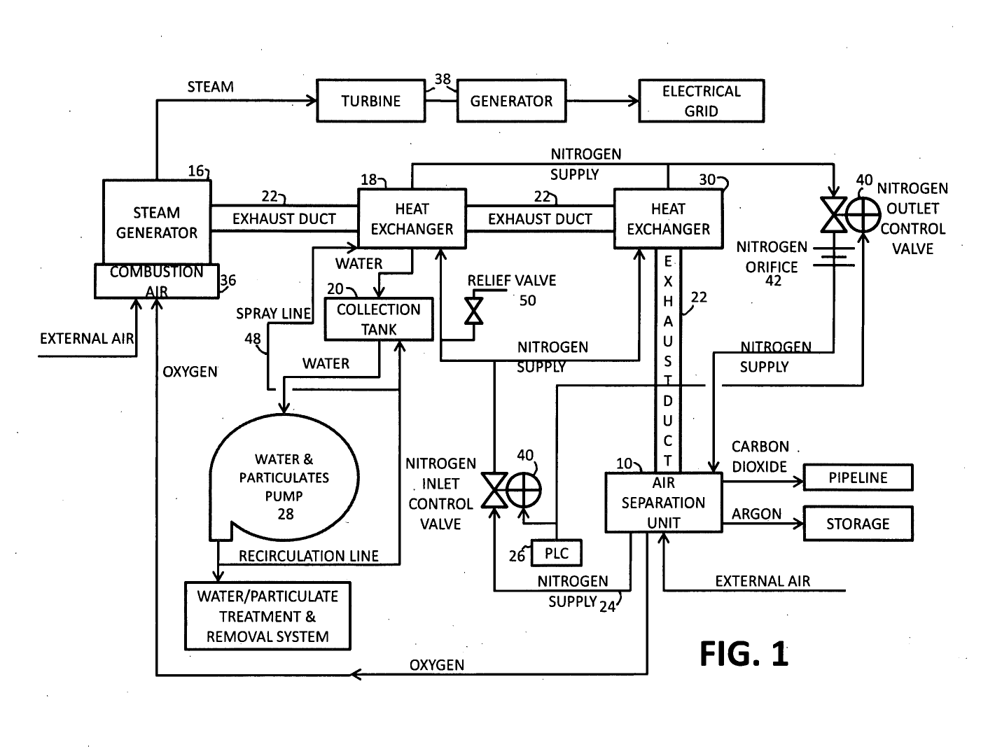

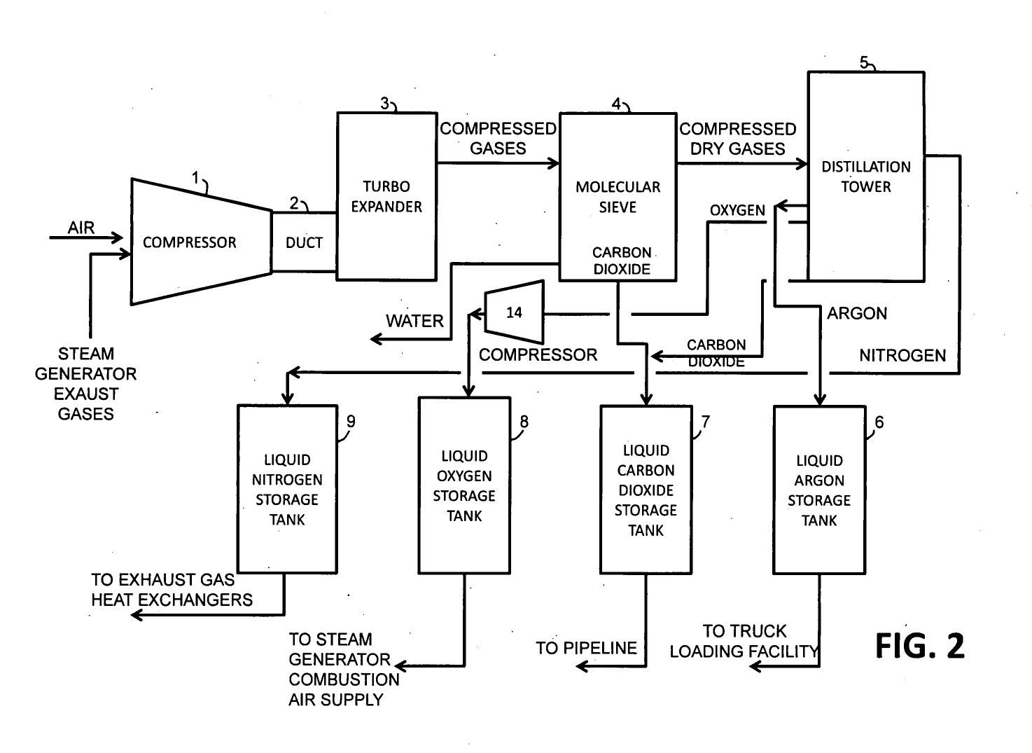

In its preferred embodiment, the air separation unit 10 comprises a heat exchanger 30 in FIG. 1 arranged to cool the steam generator exhaust gases prior to separation of nitrogen, nitrogen oxides, oxygen, carbon dioxide, carbon monoxide, sulfur oxides, argon, and other trace gases prior to compression, a compressor 1 in FIG. 2 arranged to pressurize the air, directed through a duct 2 to a molecular sieve 4 to separate water and carbon dioxide from the compressed air and a turbo-expander 3, or other mechanical means, to cool the compressed air prior to separation of nitrogen and all other gases, and distillation tower 5 in FIG. 2 arranged to separate the nitrogen, nitrogen oxides, carbon dioxide, carbon monoxide, oxygen, argon, and other trace gases from the air. Liquid nitrogen tank 9, liquid oxygen storage tank 8, liquid carbon dioxide storage tank 7, and liquid argon storage tank 6 hold the liquid gases produced.

The preferred invention also includes heat exchanger/moisture removal units comprising a heat exchanger 18 using liquid/gaseous nitrogen to cool the exhaust gases, condense the water vapor, trap particulates and acid gases, a particulates/water pump 28, a particulates/water collection tank 20, and arranged and controlled to prevent icing in the exhaust gas duct 22. The exhaust duct sections are all part of the same duct carrying exhaust gases. The heat exchangers 18 and 30 will be constructed inside the exhaust gas duct of the steam generator 16, a nitrogen supply system 24 from the liquid nitrogen storage tank, a nitrogen control system using a programmable logic controller (PLC) 26, a particulates/water pump 28 to pump particulates and water to a treatment facility, a secondary heat exchanger 30 using liquid/gaseous nitrogen to cool the exhaust gases and a duct/piping system comprising exhaust ducts 22 arranged to carry the cooled gases back to the ASU for liquefaction.

In addition the power plant further preferably comprises a compressor 14 arranged to pressurize the liquid oxygen from a distillation tower 5 prior to directing the liquid oxygen to the steam generator 16 for injection into the combustion air 36 and heat exchangers 18 and 30 arranged such that the cold nitrogen gas from said air separation unit 10 is used to cool the exhaust gases prior to passage of the gases through said air separation unit 10.

The invention herein further comprises a method of generating electricity with zero pollutant emissions in a power plant having a steam generator, said method consisting of arranging the steam generator to combust a fuel in the presence of air and substantially pure oxygen gas, with the steam generator producing high quality steam to power a steam turbine-generator 38 for the production of electricity, and to produce an exhaust gas consisting essentially of water, nitrogen, nitrogen oxides, carbon dioxide, carbon monoxide; oxygen, sulfur oxides, argon, and other trace gases; recovering all gases from the exhaust gas; recycling all of the recovered exhaust gases for passage through the air separation unit 10; separating nitrogen, carbon dioxide, argon, water vapor, oxygen, and other trace gases from air and producing a stream of substantially pure liquid nitrogen, carbon dioxide, oxygen, and argon; directing said substantially pure liquid nitrogen to cool the water vapor and exhaust gases prior to the air separation unit, and liquefying all the gases for removal from the plant.

In the invention, liquid nitrogen produced by an air separation unit (ASU) is used to chill the stack gas to a temperature of approximately 35° F. via closed cycle heat exchangers in order to remove water vapor from the gas flow and chill the remaining gases. Cryogenic cooling of the stack gas to 35° F. requires approximately ⅔ of the equivalent steam generator air flow in liquid nitrogen volume.

The preferred material for the two exhaust gas heat exchangers is Carpenter 20 steel due to the possibility of acid formation at the water collection point. Following expansion, the nitrogen gas is recovered by compression to a liquid by routing the nitrogen gas back to the ASU. The heat exchanger is multi-pass and is sized to the boiler stack gas flow and boiler exhaust gas duct dimensions.

Temperature regulation is accomplished by nitrogen inlet and outlet control valves 40 on the inlet and outlet of the heat exchanger. An orifice 42 is installed on the downstream side of the nitrogen outlet control valve to maintain a back-pressure condition on the outlet regulating valve to prevent wear (cavitation) on the seat of the valve. The control (or regulating) valve position is controlled by temperature sensors placed on the outlet of the heat exchanger in the exhaust gas duct. A nitrogen control system utilizing a programmable logic controller 26 (PLC) controls the flow of nitrogen to the heat exchangers by moving the inlet and outlet control valves and thereby regulating the temperature of the exhaust gas stream moving through the heat exchangers.

A relief valve 50 is installed between the regulating valves to protect against catastrophic failure of the piping or heat exchanger due to nitrogen pressure buildup, in the event of loss of signal, loss of sensors or shutdown of the generating unit. The inlet valve fails closed on loss of signal or power. The outlet valve fails open on loss of signal or power.

Water collection is via collection tank 20. A particulates/water pump 28 pumps water from the collection tank for treatment. The collection tank 20 is mechanically agitated by water flowing through a manifold from the particulates/water pump recirculation flow line to keep the fly-ash in solution for removal by the ash pump.

Chilling the stack gas results in the removal of water and trace amounts of sulfuric acid, nitric acid, and particulates. A spray line 48 from the particulates/water pump 28 is employed to spray water, which is recirculated, into the exhaust gases flow prior to the heat exchanger to enhance capture of particulates and trace amounts of sulfuric acid and nitric acid present in the exhaust gases. The condensed liquid is chemically neutralized during treatment to recover the water.

Particulates recovered with the water are treated as the equivalent of fly-ash. Particulates can be recovered by settling tank, centrifugal separation, or by filtration.

The cooled stack gas is then ducted to an Air Separation Unit for cryogenic capture of liquid CO₂, nitrogen oxides, oxygen and liquid nitrogen. The liquefied CO₂ is then pumped into a pipeline for use in enhanced oil recovery (EOR) or for geologic sequestration.

Oxygen captured from the flue gas, supplemented by additional oxygen produced from the ASU is routed to the forced draft (FD) fan duct to augment steam generator oxygen requirements and reduce steam generator air flow requirements. The supplemental use of oxygen for combustion, coupled with the suction on the stack gas by the ASU will significantly reduce forced draft (FD) fan and induced draft (ID) fan horsepower requirements by potentially 50%.

One principle used in the power plant of the invention is firing the fuel in highly enriched oxygen along with combustion air. The combustion of a hydrocarbon in pure O₂ produces an exhaust or flue gas consisting of only H₂O and CO₂ with possible minor dissociation products, depending on the fuel type, combustion temperature and pressure. Since H₂O is readily condensable (and reusable), the sole major combustion product is CO₂; the efficient capture thereof is the major purpose of the new plant design.

The invention introduces novel approaches and an integrated design to known state-of-the-art components. Two new aspects have been developed. The first is an integrated Air Separation and CO₂ Capture (ASU) unit. In the ASU unit, both processes of, N₂ and O₂ production and CO₂ removal (“capture”) are carried out in a thermally integrated unit that significantly reduces the equivalent power consumption of CO₂ capture. The free energy available to do work from the liquid nitrogen is used to capture CO₂ in the ASU. The integrated ASU adds between 4 to 8 percent to the overall electrical auxiliaries of the new power plant.

The major components of the new plant design include the ASU compressors and distillation towers, and exhaust gas heat exchangers, which are all commercially available. Ordinary, commercially available steam generators, turbine-generators, and ASUs, can be used in this invention.

### Process Design of the Power Plant

An overview of the power plant with CO₂ capture is given first, followed by a detailed description of the ASU unit. Modifications required for use of the ASU in a coal-fired plant are also described.

FIG. 1 shows the overall design of a power plant according to the invention. As shown in FIG. 1, air is separated in the ASU 10 into liquid oxygen, liquid nitrogen, and argon. The liquid nitrogen is utilized in the exhaust gas heat exchangers 18, 30 or vented into the atmosphere or sold as a by-product. The argon is produced as a by-product to be sold commercially. The liquid oxygen is compressed to 250 psig and sent to the steam generator 16 to be used for fuel combustion. The liquid nitrogen is sent to the heat exchangers 18, 30 in the exhaust gas duct 22 to remove water vapor and cool the remaining exhaust gases. The cooled gases are then routed to the ASU 10 (nitrogen supply system where the combustion products are liquefied for reuse in the plant or stored for sale.

The net thermal efficiency of the power plant, i.e., the electric energy generated versus the thermal energy of input, including the energy required for nitrogen, oxygen, and carbon dioxide production, nitrogen and carbon dioxide compression is 37 percent. This is about 7 percent lower than a natural gas-fired combined cycle combustion turbine plant. The cost of lower thermal efficiency is more than offset by the sale of the new by-products of this invention.

### Air Separation and CO₂ Removal (ASU)

Air separation can be accomplished using commercially available devices that use known processes such as cryogenic separation, pressure-swing adsorption, or membrane separation. The cryogenic process is preferred for use in the ASU unit.

FIG. 2 shows the overall conceptual design of the ASU. The air separation part of the ASU separates the ambient air into pure oxygen, nitrogen, and argon. The cold energy of nitrogen is used to cool the exhaust gas coming from the steam generator. The water vapor in the exhaust gas is condensed and removed in the heat exchanger. The oxygen is injected into the steam generator inlet combustion air 36 in FIG. 1. The carbon dioxide gas from the exhaust gases is liquefied and transported by pipeline for sale as a by-product. Solid CO₂ can also be produced as a by-product with simple modifications of the system.

In the ASU, oxygen production and carbon dioxide capture are carried out in a thermally integrated unit. The efficiency losses due to CO₂ recovery are relatively modest when one considers the environmental gains of 100% CO₂ recovery, no sulfur oxides, no nitrogen oxides, and no particulate emissions. Furthermore, the new plants produce saleable by-products, which make them economically competitive with advanced conventional power plants.

### Other Embodiments

It is to be understood that while the invention has been described in conjunction with the detailed description thereof, that the foregoing description is intended to illustrate and not limit the scope of the invention, which is defined by the scope of the appended claims. Other aspects, advantages, and modifications are within the scope of the following claims.

What is claimed is:

1. A power plant comprising:
a) an air separation unit arranged to separate nitrogen, oxygen, carbon dioxide, and argon from air and steam generator exhaust gases and produce a stream of substantially pure liquid nitrogen, oxygen, carbon dioxide, argon, and other trace gases;
b) a steam generator or heat recovery steam generator arranged to combust a fuel in the presence of air and injected substantially pure oxygen gas to produce an exhaust gas comprising water, nitrogen oxides, nitrogen, carbon dioxide, carbon monoxide, oxygen, argon, and other trace gases; and
c) two heat exchangers to (1) remove moisture from the steam generator exhaust gas stream and (2) to cool the exhaust gases before sending them to the air separation unit for liquefaction.

2. The power plant of claim 1, wherein the fuel is selected from the group consisting of natural gas, liquefied natural gas, synthesis gas, coal, petroleum coke, biomass, municipal solid waste, or any other gaseous, liquid, or solid fuel.

3. The power plant of claim 1, wherein said air separation unit separates nitrogen from the air and produces a stream of cold, substantially pure nitrogen, and wherein the cold nitrogen is directed to cool the steam generator exhaust gases prior to separation of nitrogen, oxygen, nitrogen oxides, carbon dioxide, carbon monoxide, sulfur oxides, argon, and other traces gases.

4. The power plant of claim 3, wherein the substantially pure nitrogen is at least 98 percent nitrogen in the form of a liquid.

5. The power plant of claim 1, wherein the substantially pure liquid oxygen gas is at least 95 percent oxygen.

6. The power plant of claim 1, wherein 100 percent of the recovered exhaust carbon dioxide is liquefied and removed from the plant by pipeline or truck for enhanced oil recovery or other commercial uses.

7. The power plant of claim 1 in steady state or variable output operation, wherein an amount of carbon dioxide equal to 100 percent of the carbon dioxide produced from combustion is liquefied for removal from the plant.

8. The power plant of claim 1, wherein said air separation unit comprises a cooler arranged to cool the air prior to separation of nitrogen, nitrogen oxides, oxygen, carbon dioxide, carbon monoxide, sulfur oxides, argon, and other trace gases, a compressor arranged to pressurize the air prior to separation of nitrogen and all other gases, and distillation towers arranged to separate the nitrogen, nitrogen oxides, carbon dioxide, carbon monoxide, oxygen, argon, and other trace gases from the air.

9. The power plant of claim 1, wherein the power plant comprises (1) a heat exchanger using liquid/gaseous nitrogen to cool the exhaust gases, (2) a water/solids collection unit arranged to prevent icing in the exhaust gas duct of the steam generator, (3) a nitrogen supply system, (4) a nitrogen control system utilizing a PLC, (5) a particulates/water pump to pump particulates/water to a particulates/water treatment facility, (6) a secondary heat exchanger using liquid/gaseous nitrogen to cool the exhaust gases; and (7) a duct/piping system arranged to carry the cooled gases back to the air separation unit for liquefaction.

10. The power plant of claim 1, further comprising a compressor arranged to pressurize the liquid oxygen from a distillation tower prior to directing the liquid oxygen to said steam generator unit for injection into a combustion air supply system; and a heat exchanger arranged such that the cold nitrogen gas from said air separation unit is used to cool the exhaust gases prior to passage of the gases through said air separation unit.

11. The power plant of claim 5, wherein said liquid oxygen is pressurized to a pressure of at least 250 psig.

12. A method of generating electricity with zero pollutant emissions in a power plant having a steam generator, said method consisting of arranging the steam generator to combust a fuel in the presence of air and substantially pure oxygen gas, and to produce an exhaust gas consisting essentially of water, nitrogen, nitrogen oxides, carbon dioxide, carbon monoxide; oxygen, sulfur oxides, argon, and other trace gases; recovering all gases from the exhaust gas; recycling all of the recovered exhaust gases for passage through the air separation unit; separating nitrogen, carbon dioxide, argon, water vapor, oxygen, and other trace gases from air and producing a stream of substantially pure liquid nitrogen, carbon dioxide, oxygen, and argon; directing said substantially pure liquid nitrogen to cool the water vapor and exhaust gases prior to the air separation unit, and liquefying all the gases for removal from the plant.

13. The method of claim 12, wherein the fuel is selected from the group consisting of natural gas, liquefied natural gas, or synthesis gas, coal, petroleum coke, biomass, Municipal Solid Waste[MSW], or any other gaseous, liquid, or solid fuel.

14. The method of claim 12, further comprising the steps of separating nitrogen from the air and producing a stream of substantially pure nitrogen; and directing the cold nitrogen to cool the water vapor and exhaust gases prior to admission to the air separation unit.

15. The method of claim 12, further comprising the steps of compressing the substantially pure liquid oxygen gas prior to evaporation of the liquid oxygen during liquefaction of the remaining portion of the recovered carbon dioxide gas, thereby forming cold oxygen gas; and injecting the oxygen gas into the inlet combustion air of the steam generator.

16. The method of claim 12, wherein 100 percent of the recovered carbon dioxide gas is captured and the recovered carbon dioxide gas is liquefied for removal from the plant.

17. The method of claim 12, wherein during steady state or variable operation, an amount of carbon dioxide equal to 100 percent of the carbon dioxide gas produced from combustion is liquefied for removal from the plant.
